(19) United States
(12) Patent Application Publication
(10) Pub. No.: US 2024/0042572 A1
(43) Pub. Date: Feb. 8, 2024

(54) GRINDING DISC AND SUBSTRATE CLEANING DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Zehao MA, Wuhan, Hubei (CN); Haiyang SHEN, Wuhan, Hubei (CN)

(21) Appl. No.: 17/594,027

(22) PCT Filed: Sep. 14, 2021
(86) PCT No.: PCT/CN2021/118207

§ 371 Date: Sep. 30, 2021

(30) Foreign Application Priority Data
Aug. 23, 2021 (CN) 202110965606.9

(51) Int. Cl. B24B 37/14; B24B 27/00; B24B 27/033

(52) U.S. Cl. CPC B24B 37/14; B24B 27/0092; B24B 27/033

(57) ABSTRACT

The present application provides a grinding disc and a substrate cleaning device. The grinding disc includes a thickness self-adaptive layer and a base layer and a grinding plate fixed on two opposite surfaces of the thickness self-adaptive layer respectively. The base layer is connected to the grinding head. The grinding plate contacts a product to grind and clean the product. The thickness self-adaptive layer can deform based on a pressure applied by the grinding disc to the product to be cleaned such that the grinding disc completely contacts a surface of the product to be cleaned to make a cleaning area of the grinding disc achieve 100%, which can improve a cleaning rate of the product.

### FIELD OF INVENTION

The present application relates to a field of display technologies, especially to a grinding disc for cleaning a substrate included by a display device and a substrate cleaning device including the grinding disc.

### BACKGROUND OF INVENTION

Laser lift off (LLO) technology has a wide range of applications because of its simple operation and high practicability, and can effectively separate the substrate and the organic material layer without damaging the substrate. The laser lift off (LLO) technology refers that during manufacturing a flexible display panel, when a hard substrate and a flexible substrate is separated by laser, the laser penetrates the hard substrate and is absorbed by a organic material of a laser active region of the flexible substrate, and a structure of the organic material of the laser active region is damaged by the laser such that the hard substrate and the flexible substrate are separated.

### Technical Issue

Pollution or defects are on a glass would affect the laser energy absorption of the flexible substrate under the glass to causes the flexible substrate and the hard substrate on this part to not be peeled off well, which causes damage to the flexible substrate and forms a defective product. Therefore, grinding and cleaning effect is before performing laser lift off to a substrate is very important. As discovered by research, a grinding and cleaning area is influenced seriously by a degree of parallel between a grinding disc and a product. Usually, under a circumstance of the degree of parallel between a grinding disc and a product to be cleaned not qualified, an effective grinding area is only 30%, and long term grinding causes deviation such that adjustment each time spends long time and a stable effect cannot be kept for long time, which influences a production rate. At present, the main solution adopted by mainstream equipment manufacturers is to add automatic optical monitoring at a discharge position of a cleaning machine to control dirt before entering s LLO equipment. The dirt exceeding the specification will be discharged, but this will reduce an input LLO product and seriously affect an utilization rate.

### SUMMARY OF INVENTION

### Technical Solution

To solve the above issue, technical solutions provided by the present application are as follows:

A grinding disc, wherein the grinding disc comprises:
a base layer;
a thickness self-adaptive layer disposed on the base layer, wherein the thickness self-adaptive layer is configured to deform based on pressure; and
a grinding plate disposed on a side of the thickness self-adaptive layer away from the base layer, wherein the grinding plate is adapted for contacting a product to grind and clean the product.

In an embodiment, a thickness range of the thickness self-adaptive layer is 4 to 5 millimeters, and a hardness range of the thickness self-adaptive layer is 30HRC-40HRC.

In an embodiment, a thickness range of the grinding plate is 0.5 to 1 millimeter.

In an embodiment, a metal pad is disposed between the thickness self-adaptive layer and the grinding plate, a center of the metal pad coincides with a center of the grinding plate and a center of the thickness self-adaptive layer, and a diameter of the metal pad is less than a diameter of the grinding plate.

In an embodiment, a ratio of the diameter of the metal pad to the diameter of the grinding plate is between one-fifth to one-fourth.

In an embodiment, a thickness range of the metal pad is 0.2 to 0.3 millimeters.

In an embodiment, a material of the thickness self-adaptive layer is foam or foam pad.

In an embodiment, a water-proof material layer is disposed on a periphery of the thickness self-adaptive layer.

In an embodiment, a flange is disposed on a periphery of the grinding plate, and a height of the flange is less than a thickness of the thickness self-adaptive layer when a deformation amount of the thickness self-adaptive layer is maximum.

The present application also relates to a substrate cleaning device.

A substrate cleaning device comprises grinding head a grinding head and a grinding disc connected to the grinding head, and the grinding disc comprises:
a base layer;
a thickness self-adaptive layer disposed on the base layer, wherein the thickness self-adaptive layer is configured to deform based on pressure; and
a grinding plate disposed on a side of the thickness self-adaptive layer away from the base layer, wherein the grinding plate is adapted for contacting a product to grind and clean the product.

In an embodiment, a thickness range of the thickness self-adaptive layer is 4 to 5 millimeters, and a hardness range of the thickness self-adaptive layer is 30H RC-40HRC.

In an embodiment, t a thickness range of the grinding plate is 0.5 to 1 millimeter.

In an embodiment, a metal pad is disposed between the thickness self-adaptive layer and the grinding plate, a center of the metal pad coincides with a center of the grinding plate and a center of the thickness self-adaptive layer, and a diameter of the metal pad is less than a diameter of the grinding plate.

In an embodiment, the grinding plate is a magnetic metal material, and the metal pad and the grinding plate are attached and fixed to each other magnetically.

In an embodiment, a ratio of the diameter of the metal pad to the diameter of the grinding plate is between one-fifth to one-fourth.

In an embodiment, a thickness range of the metal pad is 0.2 to 0.3 millimeters.

In an embodiment, a material of the thickness self-adaptive layer is foam or foam pad.

In an embodiment, a water-proof material layer is disposed on a periphery of the thickness self-adaptive layer.

In an embodiment, a flange is disposed on a periphery of the grinding plate, and a height of the flange is less than a thickness of the thickness self-adaptive layer when a deformation amount of the thickness self-adaptive layer is maximum.

In an embodiment, the grinding head is detachably connected to the grinding disc.

### Advantages

The grinding disc and the substrate cleaning device provided by the present application dispose a thickness self-adaptive layer on an end of a grinding plate away from a grinding surface to make the thickness self-adaptive layer able to deform based on a pressure applied by the grinding disc to a product to be cleaned such that the grinding disc can complete fit a surface of the product to be cleaned to increase a contact area between the grinding plate and the product to be cleaned, which overcomes blind spots of cleaning due to the non-parallel grinding plate and product, improves cleaning effect, and drastically enhances a product rate.

### DESCRIPTION OF DRAWINGS

FIG. 1 is a schematic structural view of a usage scenario of a grinding disc provided by the embodiment of the present application;

FIG. 2 is a schematic cross-sectional view the grinding disc of a first embodiment of the present application;

FIG. 3 is a schematic cross-sectional view of the grinding disc of a second embodiment of the present application;

FIG. 4 is a schematic exploded structural view of the grinding disc in FIG. 3.

FIG. 5 is a schematic cross-sectional view of the grinding disc of a third embodiment of the present application;

FIG. 6 is a schematic cross-sectional view of the grinding disc provided by a fourth embodiment of the present application; and

FIG. 7 is a schematic cross-sectional view of the grinding disc provided by a fifth embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

In the description of the present application, it should be understood that terminologies “longitudinal”, “transverse”, “length”, “width”, “thickness”, “upper”, “lower”, “front”, “rear”, “left”, “side”, “vertical”, “horizontal” for indicating relations of orientation or position are based on orientation or position of the accompanying drawings, are only for the purposes of facilitating description of the present application and simplifying the description instead of indicating or implying that the referred device or element must have a specific orientation or position, must to be structured and operated with the specific orientation or position. Therefore, they should not be understood as limitations to the present application. Furthermore, terminologies “first”, “second” are only for the purposes of description, and cannot be understood as indication or implication of comparative importance or a number of technical features. Therefore, a feature limited with “first”, “second” can expressly or implicitly include one or more features. In the description of the present application, a meaning of “a plurality of” is two or more, unless there is a clear and specific limitation otherwise.

The present application may repeat reference numerals and/or reference letters in different examples. The repetition is for the purpose of simplification and clarity, and does not by itself indicate the relationship between the various embodiments and/or settings discussed.

The display panel of the present application are described in detail in combination with specific embodiments as follows.

### Embodiment 1

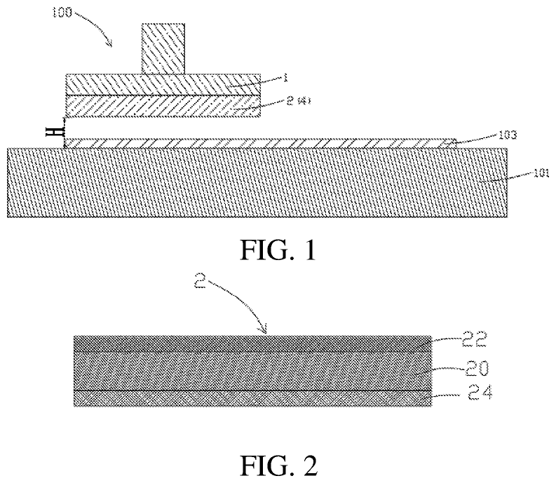

With reference to FIGS. 1 to 2, a substrate cleaning device 100 comprises: a grinding head 1 and a grinding disc 2 disposed at an end of the grinding head 1. The grinding disc 2 comprises a thickness self-adaptive layer 20 and a base layer 22 and a grinding plate 24 that are located on two opposite surfaces of the thickness self-adaptive layer 20. The grinding disc 2 is fixed to the grinding head 1 through the base layer 22. Therefore, a hardness of the base layer 22 is required to be excellent to prevent deformation. The thickness self-adaptive layer 20 has flexibility and can deform based on a pressure applied by the grinding disc 2 to a product to be cleaned 103 such that the grinding disc 2 completely fits a surface of the product to be cleaned 103.

The grinding disc 2 is detachably fixed to the grinding head 1. For example, vacuum attachment, magnetic attachment or double-sided tap adhesion can be adopted. Preferably, vacuum attachment is used for fixing to prevent residue of glue remains when the grinding disc 2 is removed and influence later cleaning effect.

In the present embodiment, thickness and material of the hard material layer has no specific requirement, any materials without deformation can be applied. For example, resin material, metal material, etc.

A thickness of the grinding plate 24 is less than a thickness of the thickness self-adaptive layer 20. An objective of such design is to make the grinding disc 2 to adapt for stretch and retraction variations of the foam. In the present embodiment, a thickness range of the grinding plate 24 is 0.5 mm-1 mm, and preferably is 0.5 millimeters, which can be adapted for a certain compression deformation of foam.

The grinding plate 24 can be selected from materials of aluminum oxide, cerium oxide, and silicon oxide. In the present embodiment, a material of the grinding plate 24 is aluminum oxide. The grinding plate 24 manufactured by the above can fulfill grinding hardness requirements and prevention of dregs.

In other embodiment, the grinding plate 24 can also be selected from materials of substances with greater hardness and magnetic.

A thickness range of the thickness self-adaptive layer 20 is 4 to 5 millimeters. A hardness range of the thickness self-adaptive layer 20 is Preferably, the hardness range of the thickness self-adaptive layer 20 is 35HRC. The thickness self-adaptive layer 20 which is over hard would result in poor scalability to fail to reach self-adaptive requirements, and the thickness self-adaptive layer 20 which is over soft would result in excessive deformation of the grinding plate 24 to wear a carrier stage 101 for carrying a product.

The thickness self-adaptive layer 20 is configured to deform based on pressure, and a material of the thickness self-adaptive layer 20 is foam, a foam pad, or a resilient element formed b a spring. Of course, other structure or material that can deform according to an external force and can restore from deformation after the external force is removed, with hardness of to 40 degrees to achieve a thickness adjustment, can be applied. In the present embodiment, the thickness self-adaptive layer 20 is foam, for example, fiber foam, strip foam, or pure color foam.

In the present embodiment, the grinding plate 24 and the thickness self-adaptive layer 20 are fixed to each other through super glue, and the thickness self-adaptive layer 20 and the base layer 22 are fixed to each other through super glue.

In some of the embodiments, the base layer 22, a diameter of the thickness self-adaptive layer 20 is the same as a diameter of of the grinding plate 24 [symbol] diameter, and the grinding disc 2 is circular or rectangular. In the present embodiment, the grinding disc 2 is circular.

The substrate cleaning device 100 is configured to be disposed on the carrier stage 101. A product to be cleaned 103 with a thickness of 0.7 mm can have grinding parameters as follows: A driving end is activated such that a height H of the grinding plate 24 from the carrier stage 101 is about 0.3 millimeters, and then a downward compression amount of the grinding disc 2 (a deformation amount of the thickness self-adaptive layer 20) is 0.2 to 0.4 millimeters, and a pressure of a grinding pneumatic cylinder is 0.16 to 0.2 Mpa, a rotation speed of the grinding head is 150 to 250 r/s. After a final check, the grinding disc 2 can completely contact the product and an effective cleaning area of the grinding disc 2 can reach 100%, which drastically enhances a yield rate.

### Embodiment 2

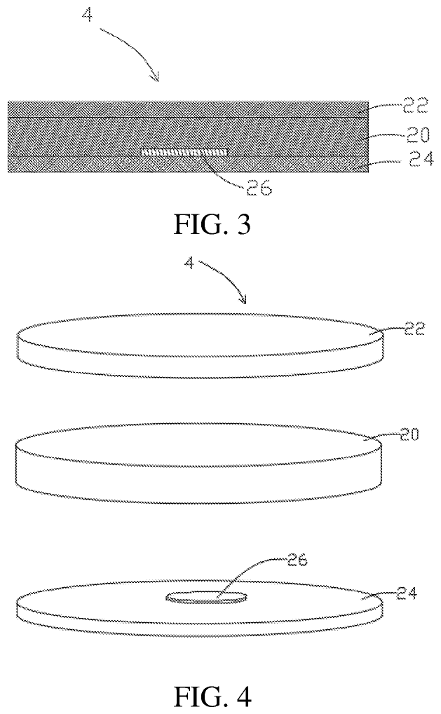

With reference to FIGS. 3 to 4, a structure of the grinding disc 4 provided by FIGS. 3 to 4 is basically the same as a structure of the grinding disc 2 provided by the first embodiment, and a difference of the grinding disc 4 in FIGS. 3 to 4 is that: A metal pad 26 is further disposed between the thickness self-adaptive layer 20 and the grinding plate 24. A center of the metal pad 26 coincides with a center of the grinding plate 24 and a center of the thickness self-adaptive layer 20, and a dimeter of the metal pad 26 is less than a diameter of the grinding plate 24.

An objective of disposing the metal pad 26 is as follows: During a grinding process of a small size product such as a wafer, a size of the grinding disc 2 is larger than a size of the product such that an edge of the grinding plate 24 receives a great force and results in a center of the grinding disc 2 is slightly higher than a periphery of the grinding disc 2 such that a substrate covered by the center portion cannot be completely grinded. Adding a layer of the metal pad 26 between thickness self-adaptive layer 20 and the grinding plate 24 would increase an amount of intervening compression of the grinding disc 2 to enhance cleaning effect.

In the present embodiment, a ratio of the diameter of the metal pad 26 to the diameter of the grinding plate 24 is between one-fifth to one-fourth. A thickness range of the metal pad 26 is 0.2-0.3 millimeters.

For example, In the present embodiment, the diameter of the grinding plate is 13 centimeters, and the diameter of the metal pad is 3 centimeters.

In the present embodiment, the grinding plate 24 is a magnetic metal material, the metal pad 26 and the grinding plate 24 are attached and fixed to each other magnetically. As such, contacting surfaces of the metal pad 26 and the grinding plate 24 completely fit each other. In one hand, the metal pad 26 can be used to reinforced a strength of the grinding plate 24. On the other hand, positions of both can be fixed securely to prevent displacement of the metal pad 26 affecting the cleaning effect.

### Embodiment 3

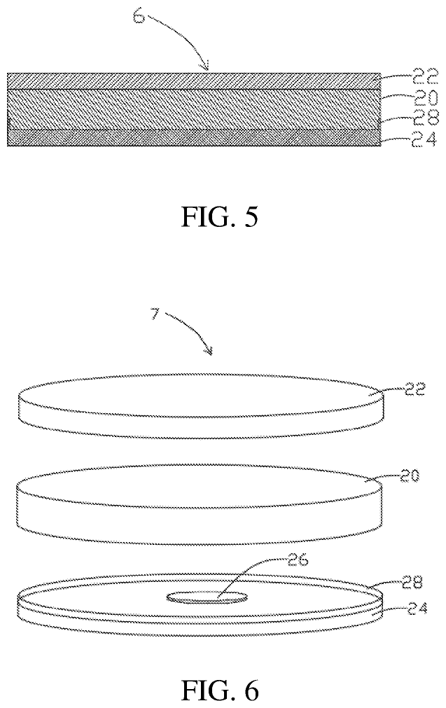

With reference to FIG. 5, a structure of the grinding disc 6 provided by FIG. 5 is basically the same as the structure of the grinding disc 2 provided by the first embodiment, and a difference of the grinding disc 6 in FIG. 5 is that: A flange 28 is formed on a periphery of the grinding plate 24, and a height of the flange 28 is less than the thickness of the thickness self-adaptive layer 20 when a deformation amount of the thickness self-adaptive layer 20 is maximum. The thickness self-adaptive layer 20 is disposed in an accommodation recess formed by the flange 28 and an upper surface of the grinding plate 24. In a preferred embodiment, a height range of the flange 28 is 1.5 to 2.5 millimeters.

An objective of disposing the flange 28 is as follows: Because during the grinding and cleaning process, deionized water is sprayed on a surfacer of the substrate, and the flange 28 is utilized to prevent sewage such as the deionized water from entering the thickness self-adaptive layer 20 from a circumference surface of the thickness self-adaptive layer 20. The height of the flange 28 less than the thickness of the thickness self-adaptive layer 20 when the deformation amount of the thickness self-adaptive layer is maximum, is for not influencing a self-adaptive characteristic of the thickness self-adaptive layer 20 such that the thickness self-adaptive layer 20 can excellently fit the surface of the product to achieve a capability of completely cleaning the surface of the product.

### Embodiment 4

With reference to FIG. 6, a structure of the grinding disc 7 provided by FIG. 6 is basically the same as the structure of the grinding disc 6 provided by FIG. 5, and a difference of the grinding disc 7 in FIG. 6 is as follows: A metal pad 26 is fixed on the grinding plate 24 to increase an amount of intervening compression of the grinding disc 2 and also to increase a contact area between the grinding disc 6 and the product to improve cleaning effect.

### Embodiment 5

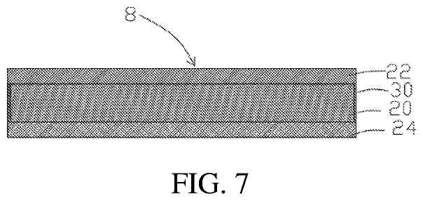

With reference to FIG. 7, a structure of the grinding disc 8 provided by FIG. 7 is basically the same as the structure of the structure of the grinding disc 2 provided by the first embodiment, and a difference of the grinding disc 8 provided by FIG. 7 is as follows: A water-proof coating layer 30 is disposed on a circumference surface of the thickness self-adaptive layer 20, and the water-proof coating layer 30 is used to completely seal a small hole with of the circumference surface of the thickness self-adaptive layer 20.

An objective of disposing the water-proof coating layer 30 is as follows: Because during the grinding and cleaning process, deionized water is sprayed on the surface of the substrate, the water-proof coating layer 30 is utilized to prevent sewage such as deionized water from entering the thickness self-adaptive layer 20 through the circumference surface of the thickness self-adaptive layer 20.

Of course, it can be understood that in the present embodiment, the metal pad 26 can also be added between the thickness self-adaptive layer 20 and the grinding plate 24.

As described above, advantages of the present application are as follows: The substrate cleaning device 100 provided by the present application disposes a thickness self-adaptive layer 20 on an end of a grinding plate 24 away from a grinding surface to make the thickness self-adaptive layer 20 able to deform based on a pressure applied by the grinding disc 2 to a product to be cleaned 103 such that the grinding disc 2 can complete fit a surface of the product to be cleaned 103 to increase a contact area between the grinding plate 24 and the product to be cleaned 103, which overcomes blind spots of cleaning due to the non-parallel grinding plate 24 and product, improves cleaning effect, and drastically enhances a product rate.

For a condition that the size of the grinding disc 4, 7 is greater than that of the product to be cleaned 103, a layer of the metal pad 26 is added between the thickness self-adaptive layer 20 and the grinding plate 24, which can increase an amount of intervening compression of the grinding disc 4, 7 to enhance cleaning effect.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

What is claimed is:

1. A grinding disc, wherein the grinding disc comprises:
a base layer;
a thickness self-adaptive layer disposed on the base layer, wherein the thickness self-adaptive layer is configured to deform based on pressure; and
a grinding plate disposed on a side of the thickness self-adaptive layer away from the base layer, wherein the grinding plate is adapted for contacting a product to grind and clean the product.

2. The grinding disc according to claim 1, wherein a thickness range of the thickness self-adaptive layer is 4 to 5 millimeters, and a hardness range of the thickness self-adaptive layer is 30HRC-40HRC.

3. The grinding disc according to claim 1, wherein a thickness range of the grinding plate is 0.5 to 1 millimeter.

4. The grinding disc according to claim 1, wherein a metal pad is disposed between the thickness self-adaptive layer and the grinding plate, a center of the metal pad coincides with a center of the grinding plate and a center of the thickness self-adaptive layer, and a diameter of the metal pad is less than a diameter of the grinding plate.

5. The grinding disc according to claim 4, wherein a ratio of the diameter of the metal pad to the diameter of the grinding plate is between one-fifth to one-fourth.

6. The grinding disc according to claim 4, wherein a thickness range of the metal pad is 0.2 to 0.3 millimeters.

7. The grinding disc according to claim 1, wherein a material of the thickness self-adaptive layer is foam or foam pad.

8. The grinding disc according to claim 1, wherein a water-proof material layer is disposed on a periphery of the thickness self-adaptive layer.

9. The grinding disc according to claim 1, wherein a flange is disposed on a periphery of the grinding plate, and a height of the flange is less than a thickness of the thickness self-adaptive layer when a deformation amount of the thickness self-adaptive layer is maximum.

10. A substrate cleaning device, comprising a grinding head and a grinding disc connected to the grinding head, wherein the grinding disc comprises:
a base layer;
a thickness self-adaptive layer disposed on the base layer, wherein the thickness self-adaptive layer is configured to deform based on pressure; and
a grinding plate disposed on a side of the thickness self-adaptive layer away from the base layer, wherein the grinding plate is adapted for contacting a product to grind and clean the product.

11. The substrate cleaning device according to claim 10, wherein a thickness range of the thickness self-adaptive layer is 4 to 5 millimeters, and a hardness range of the thickness self-adaptive layer is 30HRC-40HRC.

12. The substrate cleaning device according to claim 10, wherein a thickness range of the grinding plate is 0.5 to 1 millimeter.

13. The substrate cleaning device according to claim 10, wherein a metal pad is disposed between the thickness self-adaptive layer and the grinding plate, a center of the metal pad coincides with a center of the grinding plate and a center of the thickness self-adaptive layer, and a diameter of the metal pad is less than a diameter of the grinding plate.

14. The substrate cleaning device according to claim 13, wherein the grinding plate is a magnetic metal material, and the metal pad and the grinding plate are attached and fixed to each other magnetically.

15. The substrate cleaning device according to claim 13, wherein a ratio of the diameter of the metal pad to the diameter of the grinding plate is between one-fifth to one-fourth.

16. The substrate cleaning device according to claim 13, wherein a thickness range of the metal pad is 0.2 to 0.3 millimeters.

17. The substrate cleaning device according to claim 10, wherein a material of the thickness self-adaptive layer is foam or foam pad.

18. The substrate cleaning device according to claim 10, wherein a water-proof material layer is disposed on a periphery of the thickness self-adaptive layer.

19. The substrate cleaning device according to claim 10, wherein a flange is disposed on a periphery of the grinding plate, and a height of the flange is less than a thickness of the thickness self-adaptive layer when a deformation amount of the thickness self-adaptive layer is maximum.

20. The substrate cleaning device according to claim 10, wherein the grinding head is detachably connected to the grinding disc.
